(19) United States
(12) Patent Application Publication
(10) Pub. No.: US 2008/0279601 A1
(43) Pub. Date: Nov. 13, 2008

(54) IMAGE FORMING APPARATUS

(75) Inventors: Hiroshi Sahara, Susono-shi (JP); Takayuki Kato, Kashiwa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/110,673

(22) Filed: Apr. 28, 2008

(30) Foreign Application Priority Data
May 7, 2007 (JP) 2007-122419

(51) Int. Cl. G03G 15/23; B65H 29/00

(52) U.S. Cl. 399/401; 271/186

(57) ABSTRACT

An image forming apparatus includes an image forming portion which forms a toner image on a sheet; a fixing rotary member pair which fixes the toner image onto the sheet; a reversing rotary member pair capable of performing a refeeding operation in which, in order to form a toner image on another surface of the sheet having one surface on which an image has been formed, the reversing rotary member pair rotates forward and then rotates backward to refeed the sheet toward the image forming portion; and a drive portion which drives the fixing rotary member pair and the reversing rotary member pair by a common drive source, wherein the drive portion can continue to rotate the fixing rotary member pair even when the drive portion stops the refeeding operation of the reversing rotary member pair.

### BACKGROUND OF THE INVENTION

1. Field of the Invention

The present invention relates to an image forming apparatus for forming images on both surfaces of a recording material (sheet).

2. Description of the Related Art

Conventionally, as an image forming apparatus adopting electrostatic recording, or electrophotographic process, there is provided an image forming apparatus capable of forming images on both surfaces of a recording material. In the image forming apparatus of this type, an image is formed on one surface of the recording material in an image forming portion, the recording medium is then reversed, and an image is also formed on another surface of the recording material again in the image forming portion.

FIG. 12 is a sectional view taken along a conveying direction of the recording material in the conventional image forming apparatus capable of forming images on both surfaces of the recording material. FIGS. 13 and 14 are views each illustrating gear trains for transmitting a rotational force of a motor 670 to a discharge reversing roller pair 680 and a fixing device 640.

An operation of an image forming apparatus 600 is described hereinafter.

The image forming apparatus 600 includes a multi-color image forming apparatus and includes an image forming portion 610 constituting four photosensitive drums 611 corresponding to four colors. Toner images are formed on the four photosensitive drums 611, and the toner images are primarily transferred onto a belt-like intermediate transferring body 630 which performs circulation by being successively overlapped each other.

A pickup roller 622 served as a feeder picks up a recording material P from a sheet container 637 and feeds the recording material P to a registration roller pair 623. In a state where rotation of the registration roller pair 623 is stopped, the registration roller pair 623 receives a leading end of the recording material P, thereby correcting skew feed of the recording material P. After that, the registration roller pair 623 starts its rotation correspondingly to a position of the toner images on the intermediate transferring body 630 and feeds the recording material P into a secondary transfer position Te. A secondary transferring roller 635 abuts on a portion of the intermediate transferring body 630, which is supported by a roller 636, thereby forming the secondary transfer position Te. The secondary transferring roller 635 secondarily transfers the toner images on the intermediate transferring body onto the recording material P. After that, a fixing device 640 fixes the toner images to the recording material P. Finally, the recording material P is delivered to a discharge tray 681.

A discharge reversing roller pair 680, which is capable of rotating forward and backward, is disposed downstream in a recording material conveying direction of the fixing device 640, and is rotated by a motor 670 shared with the fixing device 640.

A rotational force of the motor 670 is transmitted to the fixing device 640 by a fixation driving train 771. The rotational force of the motor 670 is transmitted to the discharge reversing roller pair 680 by a discharge driving train 772 including a gear train.

In a case where, an image is also formed on the other surface of the recording material in the image forming apparatus 600, the discharge reversing roller pair 680 temporarily rotates forward to convey the recording material P in a discharge direction and allows the recording material P to protrude to an outside of an apparatus main body 600A of the image forming apparatus. After a rear end of the recording material P passes through the fixing device 640, the discharge reversing roller pair 680 rotates backward and cooperates with a movement guide 643 to send the recording material into a duplex conveying path 682 with the rear end of the recording material being a leading end.

The duplex conveying roller pair 683 is rotated by a motor (not shown) different from the motor 670. The duplex conveying roller pair 683 conveys the recording material P in the duplex conveying path 682 to the registration roller pair 623 via a confluent portion 684 between a feeding conveying path 620 and the duplex conveying path 682. After that, the secondary transferring roller 635 transfers the toner images on the intermediate transferring body to the recording material at the secondary transfer position Te. The fixing device 640 fixes the toner images to the recording material. Finally, the discharge reversing roller pair 680 delivers the recording material to the discharge tray 681. Through the process, a duplex image formation operation of the image forming apparatus is completed.

In FIGS. 13 and 14, the discharge reversing roller pair 680 and the fixing device 640 are rotated by the same motor 670. The rotational force of the motor 670 is transmitted to the fixing device 640 by the fixation driving train 771. The rotational force of the motor 670 is transmitted to the discharge reversing roller pair 680 by the discharge driving train 772 including the gear train.

In a case of forming toner images on both surfaces of the recording material, the discharge reversing roller pair 680 rotates forward and then backward. The forward rotation and the backward rotation are performed by forward rotation and backward rotation of the motor 670. Accordingly, the discharge driving train 772 has a structure in which, when a rotation direction of the motor 670 is switched, the rotation direction of the discharge reversing roller pair 680 is switched.

On the other hand, the fixing device 640 has to always rotate in one direction. Therefore, the fixation driving train 771 has a structure in which, even when the rotation direction of the motor 670 is switched, the rotation direction of the discharge reversing roller pair 680 is not switched.

In FIG. 13, the fixation driving train 771 includes a deceleration gear train including gears 701, 702, 711, 712, 713, 714, 716, 717, and 715. The gear 712 is rotatably supported by a rotation switching member 718. The discharge driving train 772 includes a deceleration gear train including the gears 701 and 702, and gears 721, 722, 723, and 724.

Arrows illustrated in the gears of FIG. 13 show rotation directions thereof when the discharge reversing roller pair 680 delivers the recording material to the outside of the apparatus main body 600A The rotation switching member 718 rotates about a shaft 711a of the gear 711 to allow the gear 712 to selectively mesh with the gear 713 or the gear 715. In FIG. 13, the rotation switching member 718 allows the gear 712 to mesh with the gear 713.

Arrows illustrated in the gears of FIG. 14 show rotation directions thereof when the motor 670 of FIG. 13 is rotated backward and the discharge reversing roller pair 680 reversely conveys the recording material to the duplex conveying path 682. In this case, in the fixation driving train 771, the gear 712 is allowed to mesh with the gear 715, thereby preventing the rotation direction of the fixing device 640 from changing even when the discharge reversing roller pair 680 is rotated backward (see Japanese Patent Application Laid-Open No. 2001-199610).

In this regard, there is always a demand of downsizing for the image forming apparatus. In order to achieve downsizing, one option is that a path from the discharge reversing roller pair 680 to the registration roller pair 623 via the duplex conveying path 682 and the confluent portion 684 be shorter than a length of the recording material. In this case, however, the following problem occurs.

In FIG. 12, the recording material P, on which image formation on one surface thereof is completed and which is guided to the duplex conveying path 682, has to stop temporarily at the registration roller pair 623 in order to align with the toner images primarily transferred onto the intermediate transferring body 630. Accordingly, rotation of the registration roller pair 623 is stopped, and the duplex conveying roller pair 683 conveys the recording material P to the registration roller pair 623 and then stops. However, a rear end of the recording material P can be kept conveyed by being sandwiched between the discharge reversing roller pair 680 in some cases. Accordingly, jam occurs in the recording material between the discharge reversing roller pair 680 and the duplex conveying roller pair 683.

As a countermeasure for occurrence of the jam, it is conceived that, when the rotation of the duplex conveying roller pair 683 is stopped, the rotation of the discharge reversing roller pair 680 is also stopped. However, in order to stop the rotation of the discharge reversing roller pair 680, the rotation of the motor 670 has to be stopped. Since the motor 670 also rotates the fixing device 640, when the motor 670 is in a stopped state, the rotation of the fixing device 640 is also stopped. The fixing device 640 is subjected to a temperature control in preparation for fixation in duplex image formation. When the fixing device 640 is stopped, an internal temperature is off-balanced. Accordingly, the fixation in the duplex image formation becomes difficult in some cases.

As described above, the conventional image forming apparatus has a problem of that a length of the duplex conveying path 682 has to be adjusted to a length of the recording material and it is difficult to achieve downsizing and cost reduction of the image forming apparatus.

### SUMMARY OF THE INVENTION

The object of the present invention is to provide an image forming apparatus capable of promoting downsizing of the image forming apparatus and of preventing reduction in fixation accuracy of a toner image.

According to the present invention, an image forming apparatus includes: an image forming portion which forms a toner image on a sheet; a fixing rotary member pair which fixes the toner image onto the sheet; a reversing rotary member pair capable of performing a refeeding operation in which, in order to form a toner image on another surface of the sheet having one surface on which an image has been formed, the reversing rotary member pair rotates forward and then rotates backward to refeed the sheet toward the image forming portion (10); and a drive portion which drives the fixing rotary member pair (41, 42) and the reversing rotary member pair by a common drive source(70), wherein the drive portion can continue to rotate the fixing rotary member pair even when the drive portion stops the refeeding operation of the reversing rotary member pair.

In an image forming apparatus embodying the present invention, the drive portion can continue to rotate the fixing rotary member pair even when the drive portion stops the refeeding operation of the reversing rotary member pair, thereby enabling downsizing of the image forming apparatus and preventing reduction in fixation accuracy of a toner image.

Further features of the present invention will become apparent from the following description of exemplary embodiments with reference to the attached drawings.

### BRIEF DESCRIPTION OF THE DRAWINGS

FIG. 1 is a view illustrating a drive system of a fixing device and a discharge reversing roller pair in an image forming apparatus according to a first embodiment of the present invention and illustrating rotation directions of gears when a recording material is delivered.

FIG. 2 is a view illustrating rotation directions of the gears in the drive system of FIG. 1 when the recording material is reversely conveyed.

FIG. 3 is a view illustrating rotation directions of the gears in the drive system of FIG. 1 when discharge reversing roller pair stops reversely conveying the recording material.

FIG. 4 is a schematic view of the fixing device and the discharge reversing roller pair of the image forming apparatus according to the first embodiment of the present invention.

FIG. 5 is a view of a state where the discharge reversing roller pair of the image forming apparatus according to the first embodiment of the present invention delivers the recording material.

FIG. 6 is a view of a state where the discharge reversing roller pair of the image forming apparatus according to the first embodiment of the present invention reversely conveys the recording material.

FIG. 7 is a sectional view of the image forming apparatus according to the first embodiment of the present invention, taken along a conveying direction of the recording material.

FIG. 8 is a view illustrating a drive system of a fixing device and a discharge reversing roller pair in an image forming apparatus according to a second embodiment of the present invention and illustrating rotation directions of gears when a recording material is reversely conveyed.

FIG. 9 is a view of a state where a discharge reversing roller pair of an image forming apparatus according to a third embodiment of the present invention reversely conveys a recording material.

FIG. 10 is a view of a state where, in FIG. 9, the discharge reversing roller pair stops reversely conveying the recording material.

FIG. 11 is a view of a state where, in FIG. 10, a subsequent sheet is sent to the discharge reversing roller pair.

FIG. 12 is a sectional view of a conventional image forming apparatus, taken along a conveying direction of a recording material.

FIG. 13 is a view illustrating a drive system of a fixing device and a discharge reversing roller pair in the conventional image forming apparatus and illustrating rotation directions of gears when a recording material is delivered.

FIG. 14 is a view showing rotation direction of the gears in the drive system of FIG. 13 when the recording material is reversely conveyed.

### DESCRIPTION OF THE EMBODIMENTS

Hereinafter, image forming apparatus according to each of first to third embodiments of the present invention is described with reference to the drawings. In the image forming apparatus of each of the embodiments, toner images are formed on both surfaces of the recording material (sheet). Note that, the image forming apparatus of each of the embodiments is a color image forming apparatus employing an electrophotographic image formation process. However, the image forming apparatus may be a monochrome image forming apparatus. Further, numerical values taken in the embodiments are reference numerical values, and do not limit the present invention.

### Image Forming Apparatus of First Embodiment

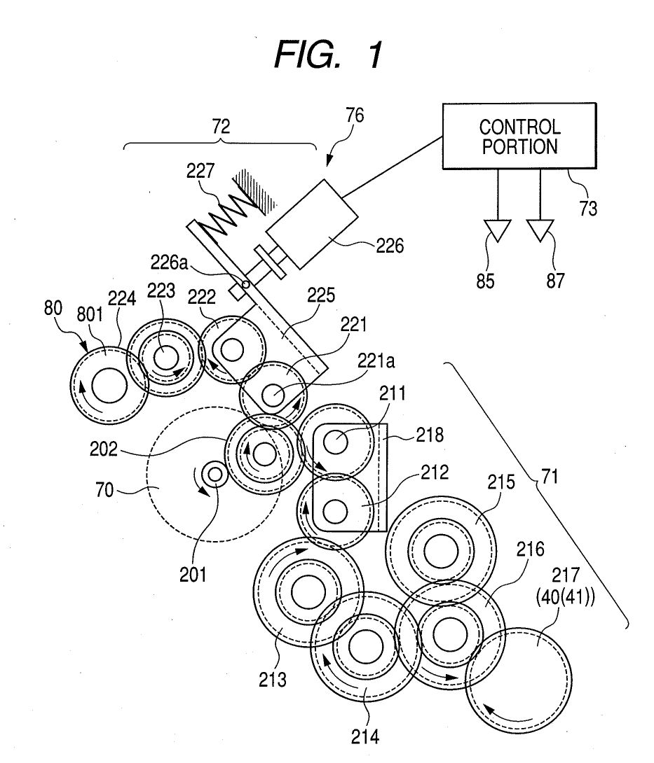

FIGS. 1 to 7 each illustrate the image forming apparatus according to the first embodiment of the present invention.

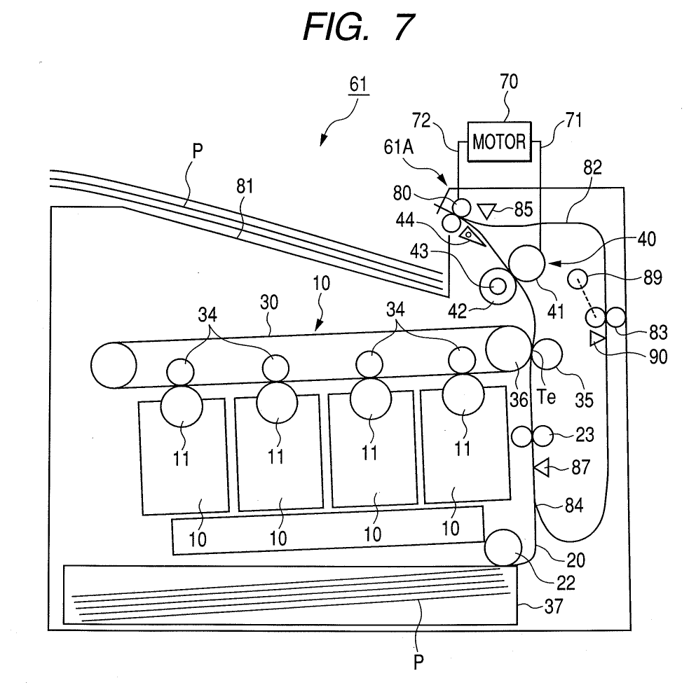

FIG. 7 is a sectional view of the image forming apparatus according to the first embodiment of the present invention, taken along a conveying direction of a recording material. An operation of an image forming apparatus 61 is schematically described.

In the image forming apparatus 61, first, latent images are formed on photosensitive drums 11 of image bearing members by using light, magnetism, or electric charge, and the latent images are visualized as toner images. On the plurality of photosensitive drums 11 constituting an image forming portion 10 and corresponding to various colors, there is disposed a belt-like intermediate transferring body 30 circulating by being pulled by multiple rollers. On an inner side of the intermediate transferring body 30, there are arranged primary charging devices 34. The intermediate transferring body 30 is brought into contact with the photosensitive drums 11 to circulate. The toner images formed on the photosensitive drums 11 are primarily transferred successively onto the intermediate transferring body 30 by the primary charging devices 34 so as to overlap each other.

On the intermediate transferring body 30, a secondary transferring roller 35 abuts in the vicinity of a roller 36 supporting the intermediate transferring body 30. The abutment position is a secondary transfer position Te. The toner images overlapping each other on the intermediate transferring body 30 are conveyed to the secondary transfer position Te by the rotation of the intermediate transferring body 30.

On the other hand, a sheet container 37 contains recording materials P. A pickup roller 22 serving as a feeder rotates to send out the recording material P from the sheet container 37. A registration roller pair 23 serving as a registration rotary member pair receives a leading end of the recording material P from the sheet container 37 in a state where rotation thereof is stopped, thereby correcting skew feed of the recording material P. After that, the registration roller pair 23 starts its rotation correspondingly to a position of the toner images on the intermediate transferring body, and sends the recording material P to the secondary transfer position Te. The secondary transferring roller 35 allows the toner images on the intermediate transferring body to be transferred onto the recording material P. After that, a fixing device 40 fixes the toner images to the recording material P, and a discharge reversing roller pair 80 positioned downstream of the fixing device 40 in a conveying direction of the recording material delivers the recording material to a discharge tray 81.

The discharge reversing roller pair 80 serving as a reversing rotary member pair is a roller pair which can rotate forward and backward. That is, the discharge reversing roller pair 80 can selectively perform a discharge operation in which discharge reversing roller pair 80 rotates forward to deliver the recording material to the discharge tray 81 or a refeeding operation in which the discharge reversing roller pair 80 rotates in one direction and then in another direction to convey the recording material to the duplex conveying path 82.

In a case where the image forming apparatus forms toner images on both surfaces of the recording material, the discharge reversing roller pair 80 temporarily rotates in the same direction as that of the fixing device 40 to convey the recording material P from the fixing device 40 in a discharge direction. As a result, the recording material P protrudes to an outside of an apparatus main body 61A of the image forming apparatus. After the rear end of the recording material P passes through the fixing device 40, the discharge reversing roller pair 80 rotates backward (in another direction) and cooperates with a movement guide 44, thereby sending the recording material P into the duplex conveying path 82 with the rear end of the recording material P being a leading end.

A duplex conveying roller pair 83 on the duplex conveying path 82 conveys the recording material P sent into the duplex conveying path 82 to the registration roller pair 23 via a confluent portion 84 between a sheet conveying path 20 and the duplex conveying path 82. After that, at the secondary transfer position Te, the secondary transferring roller 35 transfers the toner images on the intermediate transferring body onto the recording material P. The fixing device 40 fixes the toner images onto the recording material P. Finally, the discharge reversing roller pair 80 discharges the recording material P to the discharge tray 81. The duplex image formation operation of the image forming apparatus is then completed. Note that a path from the discharge reversing roller pair 80 to the registration roller pair 23 via the duplex conveying path 82 and the confluent portion 84 is shorter than a maximum length in the conveying direction of the recording material which can be conveyed by the image forming apparatus.

By the way, the registration roller pair 23 stops its rotation when the recording material P is conveyed. The duplex conveying roller pair 83 continues its rotation to press the leading end of the recording material P against the registration roller pair 23 whose rotation is stopped for bending the recording material P, thereby correcting the skew feed of the recording material P. After the skew feed correction, the duplex conveying roller pair 83 temporarily stops its rotation. After that, when the registration roller pair 23 starts conveying the recording material to the secondary transfer position Te correspondingly to the position of the toner images on the intermediate transferring body, the duplex conveying roller pair 83 restarts its rotation to convey the recording material.

In a case where the length of the recording material P is longer than the distance from the discharge reversing roller pair 80 to the registration roller pair 23 via the duplex conveying path 82, although the recording material P reaches the registration roller pair 23, the recording material P exists at the position of the discharge reversing roller pair 80. Accordingly, if, although the duplex conveying roller pair 83 stops its rotation temporarily, the discharge reversing roller pair 80 conveys the recording material, jam occurs between the discharge reversing roller pair 80 and the duplex conveying roller pair 83 in some cases. In order to prevent occurrence of the jam, it suffices that, when the duplex conveying roller pair 83 stops its rotation temporarily, the discharge reversing roller pair 80 also stops its rotation.

However, the discharge reversing roller pair 80 is rotated by a motor 70 which also rotates the fixing device 40. The duplex conveying roller pair 83 is rotated by the motor 89. That is, the motor 70 serving as a drive source also rotates the fixing device 40, thereby being a drive source shared by the discharge reversing roller pair 80 and the fixing device 40.

Accordingly, when the motor 70 is in a stopped state so as to stop the rotation of the discharge reversing roller pair 80, the rotation of the fixing device 40 is also stopped. However, when the rotation of the fixing device 40 is stopped, since the fixing device 40 has been subjected to the temperature control in preparation to the duplex image formation, an internal temperature is off-balanced. As a result, it becomes difficult to fix images in the duplex image formation.

According to the image forming apparatus 61 of this embodiment, it is possible to continue rotating the fixing device 40 which is driven by the common motor 70, even if the rotation of the discharge reversing roller pair 80 stops. Hereinafter, the structure is described.

FIGS. 1 to 3 are views each illustrating gear trains for transmitting a rotational force of the motor 70 to the discharge reversing roller pair 80 and the fixing device 40.

The rotational force of the motor 70 is transmitted to the fixing device 40 by a fixation driving train 71 serving as a first transmission portion. The rotational force of motor 70 is transmitted to the discharge reversing roller pair 80 by a discharge driving train 72 serving as a second transmission portion. The drive portion which has the fixation driving train 71 and the discharge driving train 72 drives the fixing device 40 and discharge reversing roller pair 80 by the common drive motor (70)

In FIGS. 1 to 3, the fixation driving train 71 includes a deceleration gear train including gears 201, 202, 211, 212, 213, 214, 216, 217, and 215. The gear 212 is rotatably supported by a rotation switching member 218.

The discharge driving train 72 includes a deceleration gear train including the gears 201 and 202, and gears 221, 222, 223, and 224. The gear 222 can be brought into contact with and spaced apart from the gear 223 by a stopping portion 76. The gear 222 is rotatably supported by a drive blocking member 225. The drive blocking member 225 can rotate about a rotation shaft 221a of the gear 221, and is connected to a solenoid 226 serving as a blocking portion by a shaft 226a. Further, the drive blocking member 225 is pressed by a compression spring 227 in such a direction that the gear 222 and the gear 223 mesh with each other The solenoid 226 is connected to a control portion 73. The control portion 73 receives information from a downstream sensor 87, that the leading end of the recording material P conveyed to the duplex conveying path 82 passes through the duplex conveying roller pair 83, and actuates the solenoid 226.

A structure of the discharge reversing roller pair 80 is described.

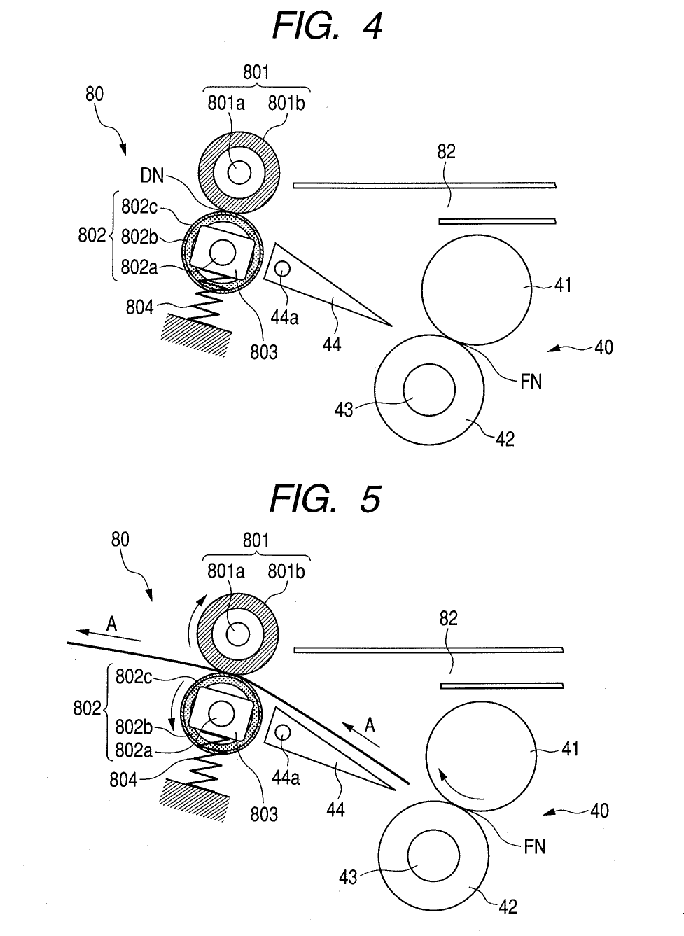

FIG. 4 is a schematic view of the vicinity of the discharge reversing roller pair 80 of FIG. 7. The discharge reversing roller pair 80 serving as a discharge reversing rotary member pair includes a drive roller 801 and a driven roller 802.

The drive roller 801 includes a metal cored bar 801a and an elastic member 801b wound around an outer periphery of the metal cored bar 801a. A length of the elastic member 801b is substantially the same as a length in a width direction of a specific recording material. Further, the elastic member 801b is made of a material having a high coefficient of friction, such as silicone rubber. At the time of conveying the recording material, the recording material can be sufficiently gripped by a tube 802c of the driven roller 802, which is made of a fluorinated resin.

The driven roller 802 includes the metal cored bar 802a, the elastic member 802b wound around the outer periphery of the metal cored bar 802a, and the tube 802c which is wound around an outer periphery of the elastic member 802b and is made of a fluorinated resin. A length of the elastic member 802b and the tube 802c is substantially the same as the length of the elastic member 801b of the drive roller 801. Both ends of the metal cored bar 802a are supported by bearings 803.

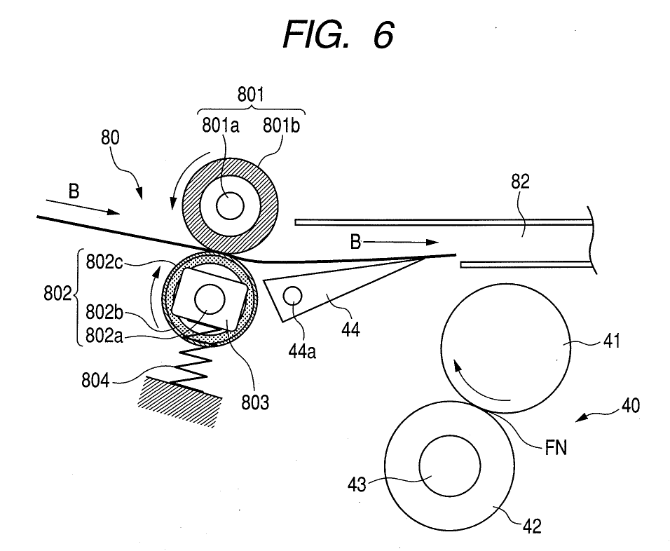

Each of the bearings 803 is pressed by the compression spring 804, thereby pressing the driven roller 802 to the drive roller 801 by a predetermined pressing force. A pressing force of 200 g to 2000 g is preferable. Further, the movement guide 44 is arranged in the vicinity of upstream in the recording material conveying direction of the discharge reversing roller pair 80. The movement guide 44 guides the recording material P, which is conveyed from the fixing device 40, to the discharge reversing roller pair 80 (FIG. 5). Further, the movement guide 44 guides the recording material P, which is reversed by the discharge reversing roller pair 80, to the duplex conveying path 82 (in a direction of arrows B) (FIG. 6).

A structure of the fixing device 40 is described.

In FIGS. 4 and 5, the fixing device 40 includes a pressure roller 41 serving as a fixing rotary member pair, a fixing roller 42, and a heater 43 provided in the fixing roller 42, and pressurizes and heats the sheet to fix the toner images to the sheet. The pressure roller 41 is always rotated by the fixation driving train 71 regardless of a rotation direction of the motor 70.

Next, an operation of delivering the recording material to the discharge tray 81, an operation of reversely conveying the recording material, and an operation of preventing occurrence of jam is described.

(Description of Operation of Delivering Recording Material to Discharge Tray 81)

FIG. 1 is a view for describing an operation of delivering the recording material to the discharge tray 81. Arrows illustrate rotation directions of the gears.

In FIG. 1, the motor 70 rotates counterclockwise as illustrated by the arrows. By the rotation of the motor 70, the rotation switching member 218 rotates about the shaft 211a of the gear 211 and allows the gear 212 to mesh with the gear 213. The drive blocking member 225 is pressed by the compression spring 227 to be rotated about the rotation shaft 221a of the gear 221, thereby allowing the gear 222 to mesh with the gear 223.

As illustrated in FIGS. 4 and 5, the movement guide 44 guides the recording material P which has passed through the fixing device 40 to the discharge reversing roller pair 80. The discharge reversing roller pair 80 conveys the recording material P in a direction of arrows A of FIG. 5 to deliver the recording material P to the discharge tray 81 of the apparatus main body 61A of FIG. 7.

(Description of Operation of Reversely Conveying Recording Material)

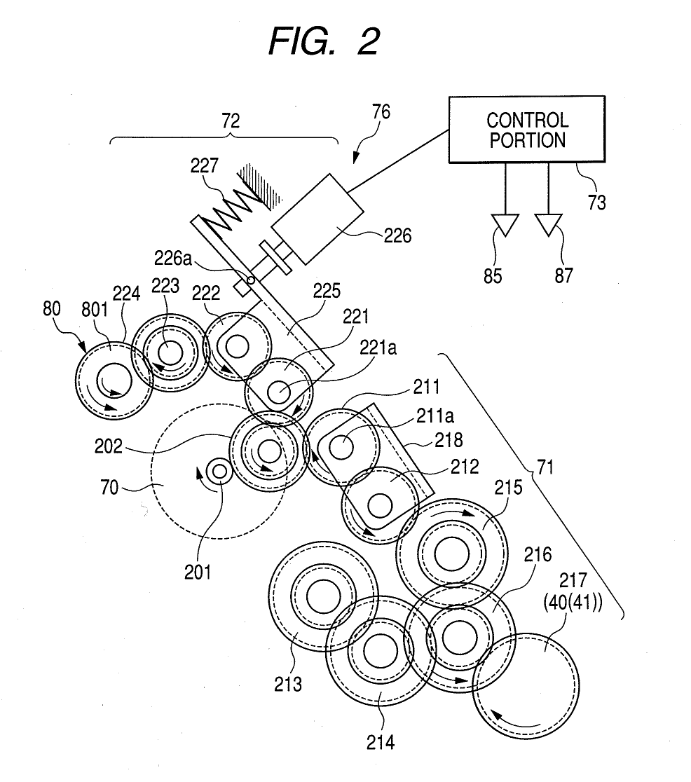

In an operation of delivering the recording material to the discharge tray 81, when the rear end of the recording material P passes through a fixing nip FN of the fixing device 40 as illustrated in FIG. 5, the movement guide 44 rotates about the shaft 44a as illustrated in FIG. 6. The movement guide 44 is rotated by a plunger (not shown). Further, as shown in FIG. 2, the motor 70 is reversed in the arrow direction (clockwise). Along with the reversal, the gears 201, 202, 221, 222, 223, and 224, and the drive roller 801 of the discharge reversing roller pair 80 are reversed. The discharge reversing roller pair 80 performs switch-back back conveyance of the recording material P to the duplex conveying path 82 of FIG. 7 with the rear end of the recording material P being a leading end. After that, when the leading end of the recording material P conveyed to the duplex conveying path 82 reaches the duplex conveying roller pair 83 (FIG. 7), the discharge reversing roller pair 80 cooperates with the duplex conveying roller pair 83 to convey the recording material.

On the other hand, when the motor 70 is reversed in the arrow direction of FIG. 2, the gears 211 and 212 are also reversed. Along with the reversal of the gear 211 and 212, the rotation switching member 218 rotates counterclockwise about the rotation shaft 211a of the gear 211 and switches the meshing of the gear 212 from the gear 213 to the gear 215. Accordingly, even when the rotation direction of the motor 70 is switched, the pressure roller 41 and the fixing roller 42 of the fixing device 40 continue to rotate in the same directions, thereby being retained so as to be capable of fixing the toner images onto the recording material to be conveyed next.

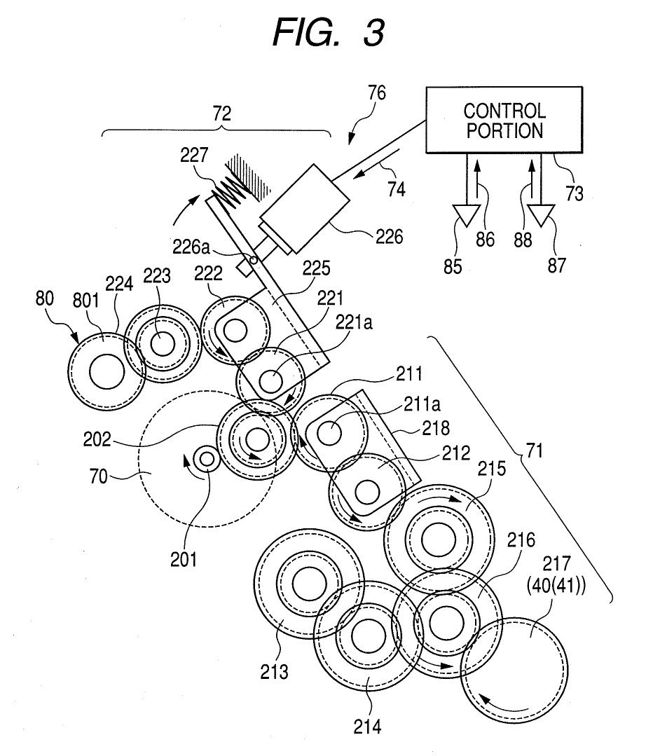

When the leading end of the recording material reaches the downstream sensor 87 disposed in the vicinity of an inlet of the registration roller pair 23 illustrated in FIG. 7, the downstream sensor 87 detects the leading end of the recording material and sends a leading end detection signal 88 (FIG. 3) to the control portion 73.

At this time point, in a case where the length of the recording material is shorter than the distance from the discharge reversing roller pair 80 to the registration roller pair 23 via the duplex conveying path 82, an upstream sensor 85 (FIG. 7) disposed in the vicinity of downstream of the discharge reversing roller pair 80 does not detect the rear end of the recording material. In this case, the control portion 73 reverses the motor 70 to rotate the discharge reversing roller pair 80 in the direction illustrated in FIG. 1. That is, the discharge reversing roller pair 80 rotates in a direction capable of delivering to the discharge tray 81 the recording material to be conveyed next. At this time point, the rotation switching member 218 is switched from a state illustrated in FIG. 2 to a state illustrated in FIG. 1. As a result, when the motor 70 is reversed, the discharge reversing roller pair 80 is not reversed.

The duplex conveying roller pair 83 continues its rotation to presses the leading end of the recording material against the registration roller pair 23 whose rotation is stopped. The recording material is bent to some degree. As a result, skew feed of the recording material is corrected. The duplex conveying roller pair 83 allows the recording material to be bent and then stops its rotation, thereby stopping conveying the recording material. After that, the registration roller pair 23 starts its rotation to convey the recording material such that the recording material corresponds to the position of the toner images primarily transferred onto the intermediate transferring body 30. The duplex conveying roller pair 83 also starts its rotation to contribute to the conveyance of the recording material.

(Operation of Preventing Occurrence of Jam)

In the description of the operation of reversely conveying the recording material, when the length of the recording material is longer than the distance from the discharge reversing roller pair 80 to the registration roller pair 23 via the duplex conveying path 82, the upstream sensor 85 detects the rear end of the recording material and sends a rear end detection signal 86 (FIG. 3) to the control portion 73. Based on the leading end detection signal 88 and the rear end detection signal 86 of FIG. 3, the control portion 73 sends an operation signal 74 to the solenoid 226. The registration roller pair 23 temporarily stops its rotation for correcting the skew feed of the recording material. A period of time longer than the period of time in which the registration roller pair 23 is stopping is stored in the control portion 73. At least while the recording material is stopping at the registration roller pair 23, the control portion 73 actuates the solenoid 226 against the compression spring 227, thereby allowing the solenoid 226 to draw and retain the drive blocking member 225. Note that the above-mentioned period of time stored in the control portion 73 may be equal to or longer than a period of time in which the duplex conveying roller pair 83 serving as a duplex conveying rotary member pair is stopping conveyance of the recording material. The solenoid 226 draws the drive blocking member 225 against the compression spring 227. The drive blocking member 225 is inclined to allow the gear 222 to be spaced apart from the gear 223, thereby blocking transmission of the rotational force from the motor 70 to the discharge reversing roller pair 80 during the period of time stored in the control portion 73.

Accordingly, while the duplex conveying roller pair 83 is pressing the leading end of the recording material to the registration roller pair 23, the discharge reversing roller pair 80 stops the conveyance of the recording material. As a result, between the duplex conveying roller pair 83 and the discharge reversing roller pair 80, jam of the recording material is prevented from occurring.

Note that an intermediate sensor 90 is disposed downstream of the duplex conveying roller pair 83. In response to detection of the leading end of the recording material by the intermediate sensor 90, the solenoid 226 may be actuated to stop the refeeding operation (conveyance of the recording material by the discharge reversing roller pair 80) The recording material is conveyed by the duplex conveying roller pair 83, and the leading end thereof is received by the registration roller pair 23 whose rotation is stopped. The recording material is temporarily stopped at the registration roller pair 23. When conveyance of the recording material is restarted by starting the rotation of the registration roller pair 23 and the duplex conveying roller 83, actuation of the solenoid 226 may be released by the control portion 73 to perform control such that a drive is transmitted to the discharge reversing roller pair 80. Even in this control, when the recording material is stopped at the registration roller pair 23, the discharge reversing roller pair 80 does not rotate. Accordingly, occurrence of jam of the recording material between the duplex conveying roller pair 83 and the discharge reversing roller pair 80 can be prevented. That is, instead of storing the stopping period of time, the control portion 73 may obtain information on conveyance stoppage of the registration roller pair 23 and the duplex conveying roller pair 83 as described above and may stop the conveyance of the recording material by the discharge reversing roller pair 80 while obtaining the information.

In the above-mentioned image forming apparatus 61, the discharge reversing roller pair 80 and the fixing device 40 are rotated by the same motor 70. Further, the length of the sheet path from the discharge reversing roller pair 80 to the registration roller pair 23 via the duplex conveying path 82 and the confluent portion 84 is set shorter than the length of the recording material.

As described above, in the image forming apparatus 61 according to this embodiment, the drive of the discharge reversing roller pair 80 is blocked. The drive portion which has the fixation driving train 71, the discharge driving train 72, drive blocking member 225, the solenoid 226 can continue to drive the pressure roller 41 and the fixing roller 42 of the fixing device 40 even when the refeeding operation of the discharge reversing roller pair 80 is stopped. As a result, the temporary stoppage of the registration roller pair 23 does not affect the fixing device 40, thereby enabling favorable images to be formed on both surfaces of the recording material. Further, the length of the duplex conveying path 82 can be made shorter, so that productivity at the time of duplex image formation can be enhanced.

Further, when the length of the sheet path from the discharge reversing roller pair 80 to the confluent portion 84 is made longer than the length of a specific recording material, in the specific recording material, there is no need to block the drive of the discharge reversing roller pair 80, and the productivity at the time of duplex image formation can be ensured. For example, by setting the path length from the discharge reversing roller pair 80 to the registration roller pair 23 via the confluent portion 84 shorter than a longitudinal length of an A3 recording material, that is, 420 mm, and by setting the path length from the discharge reversing roller pair 80 to the confluent portion 84 longer than a lateral length of an A4 recording material, that is, 210 mm, the above-mentioned productivity can be ensured.

Note that, while the drive blocking member 225 is rotated by the solenoid 226, the drive blocking member 225 may be rotated by a cam rotated by a motor. A drive source of the drive blocking member 225 is not limited to the solenoid.

### Image Forming Apparatus of Second Embodiment

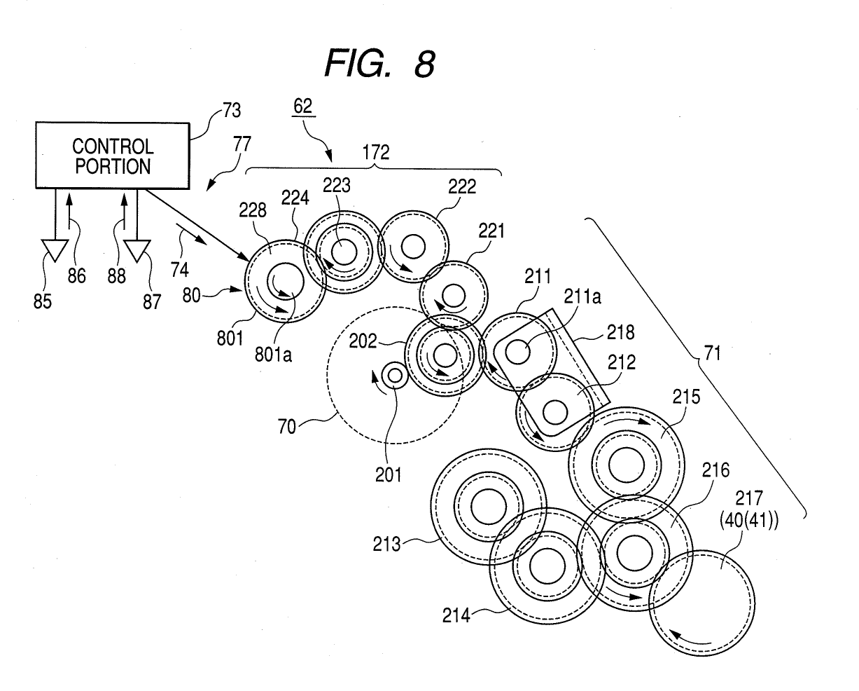

In FIG. 8, an image forming apparatus 62 has a clutch 228 serving as a blocking portion which is interposed between the gear 224 of the discharge driving train 172 and the metal cored bar 801a of the drive roller 801, so that rotation of the motor 70 can be blocked between the discharge reversing roller pair 80 and the motor 70. Note that, the clutch 228 may be provided between the gears 221 to 224. The clutch 228 and the control portion 73 constitute a stopping portion 77 serving as a stopping unit.

In this case also, the clutch 228 is actuated when the control portion 73 issues the operation signal 74 in response to the leading end detection signal 88 and the rear end detection signal 86, thereby preventing the rotation of the motor 70 from being transmitted to the discharge reversing roller pair 80. As a result, the drive roller 801 becomes rotatable. Similarly to the case of the first embodiment of the present invention, the clutch 228 is actuated by the control portion 73 during the stopping period of time stored in the control portion 73. Alternatively, it is possible for the clutch 228 to be actuated by the control portion 73 while obtaining information on conveyance stoppage of the registration roller pair 23 and the duplex conveying roller pair 83.

The image forming apparatus 62 according to the second embodiment of the present invention has the same effect as that of the image forming apparatus 61 according to the first embodiment of the present invention and can be downsized.

### Image Forming Apparatus of Third Embodiment

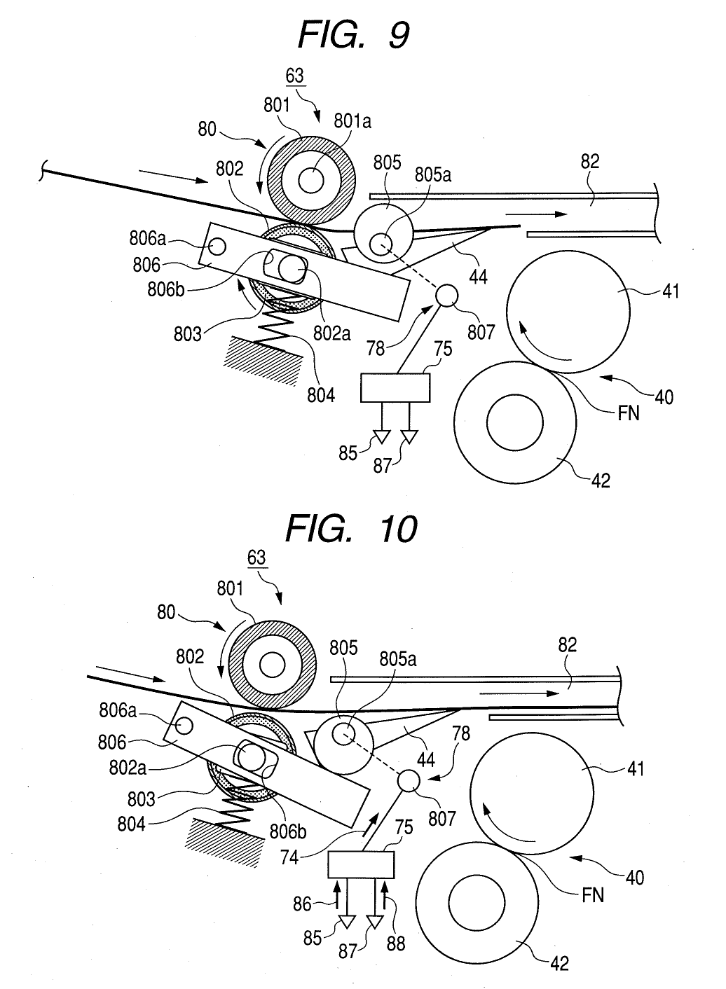

In FIG. 9, in an image forming apparatus 63, a stopping portion 78 serving as a stopping unit can moves the driven roller 802 apart from the drive roller 801 of the discharge reversing roller pair 80, thereby stopping a refeeding operation (an operation of conveying the recording material) of the discharge reversing roller pair 80.

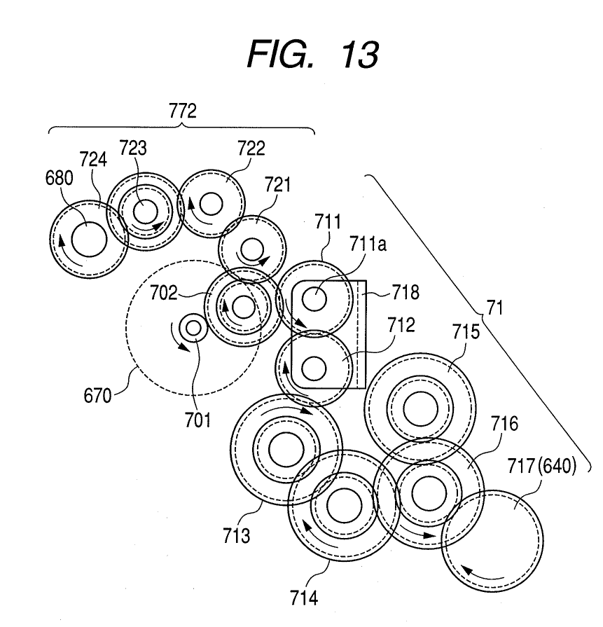

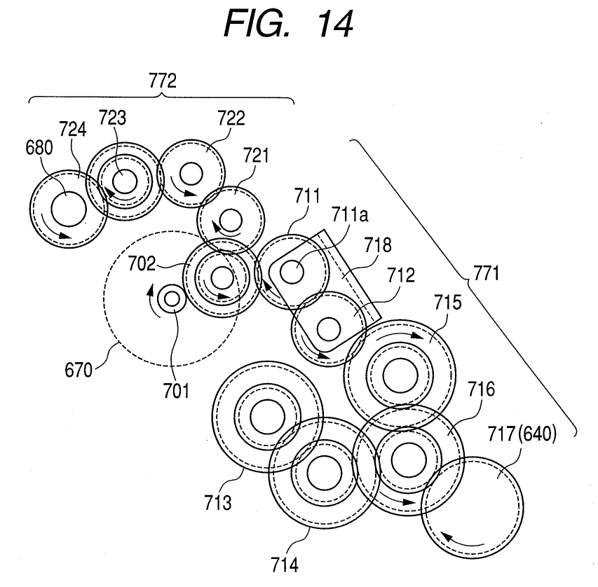

In the image forming apparatus 63 of this embodiment, the gear trains for rotating the fixing device 40 and the discharge reversing roller pair 80 are the same as the gear trains illustrated in FIGS. 13 and 14. A description is made of the image forming apparatus 63 of this embodiment with illustration of only characteristic portions thereof, and illustration and descriptions of other portions are omitted.

The cored bar 802a of the driven roller 802 of the discharge reversing roller pair 80 has both ends supported by the bearings 803, and a pressurization releasing support plate 806 is engaged with an outer side of one of the bearings 803. The pressurization releasing support plate 806 may be engaged with each end or one end of the cored bar 802a.

The pressurization releasing support plate 806 rotates about a rotation center shaft 806a. An intermediate portion of the pressurization releasing support plate 806 engages with the rotation center shaft 806a by a long hole 806b. Further, a rotation end of the pressurization releasing support plate 806 is brought into contact with a pressure releasing cam 805 serving as a spacing unit. The pressure releasing cam 805 is an eccentric cam which rotates about a rotation shaft 805a by a cam motor 807. The cam motor 807 is operated by control of the control portion 75. The control portion 75 is connected to the upstream sensor 85 and the downstream sensor 87.

As illustrated in FIG. 9, the driven roller 802 is pressed by the compression spring 804 to the drive roller 801. A nip is formed between the driven roller 802 and the drive roller 801. In this case, the pressure releasing cam 805 is spaced apart from the pressurization releasing support plate 806.

As illustrated in FIG. 10, the control portion 75 sends the operation signal 74 to the cam motor 807 in response to the leading end detection signal 88 and the rear end detection signal 86 emitted by the downstream sensor 87 and the upstream sensor 85, respectively, upon the detection of the recording material. The cam motor 807 rotates the pressure releasing cam 805. The pressure releasing cam 805 presses down the pressurization releasing support plate 806 against the compression spring 804, thereby allowing the driven roller 802 to be spaced apart from the drive roller 801. Similarly to the case of the first embodiment of the present invention, the cam motor 807 is temporarily in a stopped state by the control portion 75 during the stopping period of time stored in the control portion 75. Alternatively, the cam motor 807 may be in the stopped state by the control portion 75 while receiving information on conveyance stoppage of the registration roller pair 23 and the duplex conveying roller pair 83.

As a result, the nipping between the drive roller 801 and the driven roller 802 is cancelled, so that the discharge reversing roller pair 80 stops applying a conveying force to the recording material. The drive portion which has the fixation driving train 71, the discharge driving train 72, the pressurization releasing support plate 806, the pressure releasing cam 805, the cam motor 807 can continue to drive the pressure roller 41 and the fixing roller 42 of the fixing device 40 even when the refeeding operation of the discharge reversing roller pair 80 is stopped. In the image forming apparatus according to this embodiment, jam is not caused in the recording material even in a state in which the drive of the fixing device 40 is continued. The cam motor 807 rotates again when the stopped state is cancelled. The drive roller 801 and the driven roller 802 return to an original state in which the nipping is performed.

Accordingly, the image forming apparatus 63 of this embodiment has the same effect as that of the image forming apparatuses 61 and 62 of the first and second embodiments of the present invention.

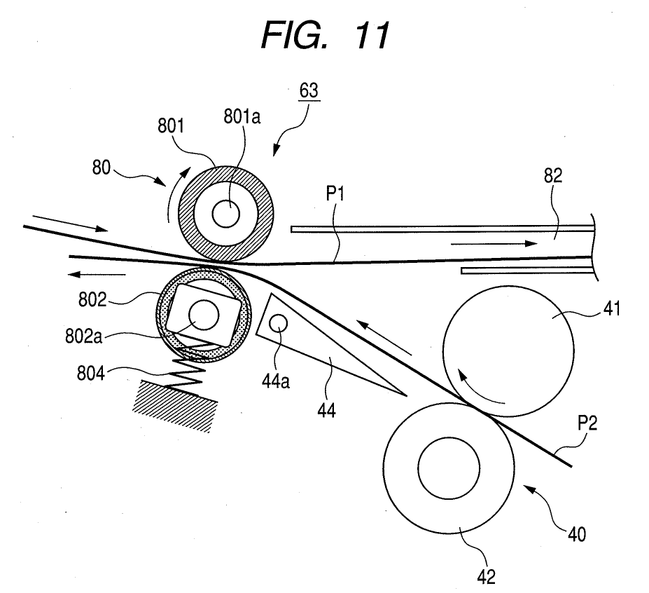

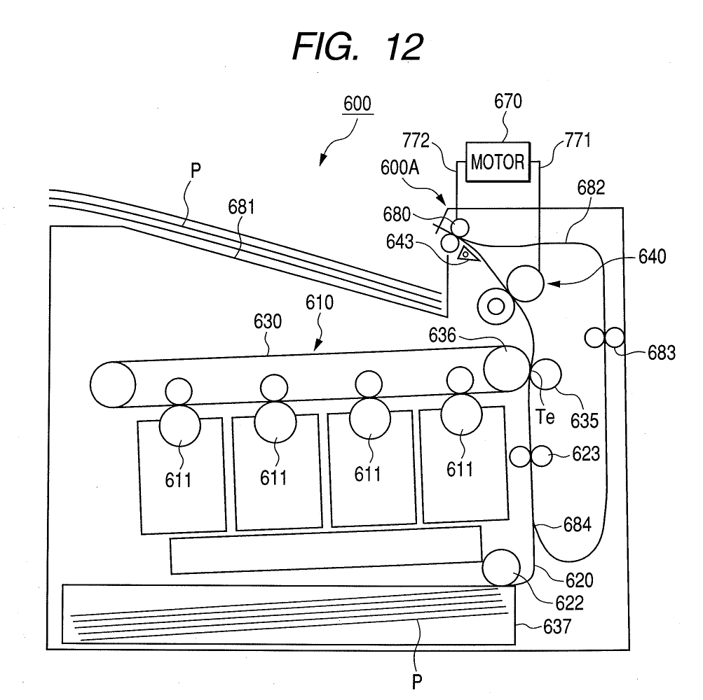

In the image forming apparatus 63 of this embodiment, a separated state of the discharge reversing roller pair 80 can be retained. Accordingly, as shown in FIG. 11, when a preceding recording material P1 is conveyed by the duplex conveying roller pair 83, a successive recording material P2 can be sent into the discharge reversing roller pair 80.

In the conventional image forming apparatus, at the time of duplex image formation, until the refeeding operation is completed in the discharge reversing roller pair 80, the next recording material cannot be conveyed to the discharge reversing roller pair 80. Accordingly, it is necessary to ensure a certain recording material interval, so image formation efficiency is low. On the contrary, in the image forming apparatus 63 of this embodiment, an interval between the recording materials can be made shorter. Accordingly, even with the recording material having a length longer than a sheet path length from the discharge reversing roller pair 80 to the registration roller pair 23, the image formation efficiency can be enhanced compared to those of the above-mentioned image forming apparatuses 61 and 62.

In the image forming apparatus according to an embodiment of the present invention, during the temporary stoppage of the conveyance of the sheet by the registration roller pair 23, the stopping portion stops the refeeding operation of the discharge reversing roller pair 80 while the motor 70 shared by the discharge reversing roller pair 80 and the fixing device 40 is operated. In the image forming apparatus according to this embodiment, there is prevented a state where, although the registration roller pair 23 stops its rotation, the sheet is refed by the discharge reversing roller pair 80. Therefore, occurrence of jam can be prevented in the sheet. Further, in the image forming apparatus according to one embodiment of the present invention, the distance between the discharge reversing roller pair 80 and the registration roller pair 23 can be made shorter, thereby enabling downsizing and cost reduction of the image forming apparatus.

Further, in the image forming apparatus according to an embodiment, even when the refeeding operation of the discharge reversing roller pair 80 is stopped, the fixing device 40 is not stopped. Accordingly, temperature control of the fixing device 40 does not become difficult, thereby enabling prevention of reduction in fixation accuracy of the toner images onto the sheet.

Further, in the image forming apparatus of an embodiment, after the sheet reaches the duplex conveying roller pair 83, while keeping the motor 70 operated, which is shared by the fixing device 40 and the discharge reversing roller pair 80, the stopping portion stops the refeeding operation of the discharge reversing roller pair 80. Accordingly, in the image forming apparatus according to this embodiment, even when, along with the temporary stoppage of the sheet by the registration roller pair 23, the duplex conveying roller pair 83 stops conveying the sheet, occurrence of jam can be prevented in the sheet between the discharge reversing roller pair 80 and the duplex conveying roller pair 83.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-122419, filed May 7, 2007, which is hereby incorporated by reference herein in its entirety.

What is claimed is:

1. An image forming apparatus, comprising:
an image forming portion which forms a toner image on a sheet;
a fixing rotary member pair which fixes the toner image onto the sheet;
a reversing rotary member pair capable of performing a refeeding operation in which, in order to form a toner image on another surface of the sheet having one surface on which an image has been formed, the reversing rotary member pair rotates forward and then rotates backward to refeed the sheet toward the image forming portion; and
a drive portion which drives the fixing rotary member pair and the reversing rotary member pair by a common drive source,
wherein the drive portion can continue to rotate the fixing rotary member pair even when the drive portion stops the refeeding operation of the reversing rotary member pair.

2. An image forming apparatus according to claim 1, wherein:
the drive source is a motor which can rotate forward and backward, and
wherein the drive portion comprises:
a first transmission portion which transmits a rotational force of the motor to the fixing rotary member pair so that, even when a rotation direction of the drive portion is switched, the fixing rotary member pair is continuously rotated in the same direction; and
a second transmission portion which transmits the rotational force of the motor to the reversing rotary member pair so that, when the rotation direction of the drive portion is switched, a rotation direction of the reversing rotary member pair is also switched.

3. An image forming apparatus according to claim 1, wherein the drive portion comprises a blocking portion which blocks transmission of the rotational force from the drive portion to the reversing rotary member pair.

4. An image forming apparatus according to claim 1, wherein the drive portion comprises a spacing portion which performs spacing of the reversing rotary member pair.

5. An image forming apparatus according to claim 1, further comprising a rotary member pair which temporarily stops the sheet, which is conveyed by the reversing rotary member pair, and then conveys the sheet to the image forming portion in accordance with a position of the toner image on the image forming portion,
wherein the drive portion stops the refeeding operation of the reversing rotary member pair while conveyance of the sheet is being stopped at the registration rotary member pair.

6. An image forming apparatus according to claim 5, wherein a length of a conveying path between the reversing rotary member pair and the rotary member pair is shorter than a length of a sheet of a maximum length capable of being conveyed in the image forming apparatus.

7. An image forming apparatus according to claim 6, further comprising:
a sheet container in which a sheet are contained;
a feeder which feeds the sheet contained in the sheet container,
wherein the rotary member pair conveys a sheet fed by the feeder and a sheet refed by the reversing rotary member pair.

8. An image forming apparatus according to claim 1, further comprising:
a duplex conveying rotary member pair which conveys the sheet conveyed by the refeeding operation of the reversing rotary member pair toward the image forming portion,
wherein after the sheet reaches the duplex conveying rotary member pair by the refeeding operation of the reversing rotary member pair, the drive portion stops the refeeding operation of the reversing rotary member pair.
